(19) United States
(12) Patent Application Publication
(10) Pub. No.: US 2026/0238590 A1
(43) Pub. Date: Aug. 13, 2026

(54) SUPI-BASED ROUTING AT SERVICE COMMUNICATIONS PROXY

(71) Applicant: Oracle International Corporation, Redwood City, CA (US)

(72) Inventors: Virendra Singh, Bengaluru (IN); Shashikiran Mahalank, Bengaluru (IN); Jay Rajput, Bengaluru (IN); Cédric Yhuel, Paris (FR)

(21) Appl. No.: 19/048,723

(22) Filed: Feb. 7, 2025

(51) Int. Cl. H04L 45/74; H04L 41/50; H04L 67/56; H04L 67/63

(52) U.S. Cl. CPC H04L 45/74; H04L 41/5058; H04L 67/56; H04L 67/63

(57) ABSTRACT

Various embodiments of the present technology generally relate to systems and methods for utilizing a service communications proxy (SCP) to perform subscription permanent identifier (SUPI)-based message routing within a 5G network. In certain embodiments, a method may comprise operating a service communications proxy (SCP) of a mobile network, including receiving a service request from a consumer network function (C-NF), the service request including a subscription permanent identifier (SUPI) value, accessing a Group ID database at the SCP based on the SUPI value, the Group ID database mapping ranges of SUPI values to groups of producer NFs configured to service particular ranges of SUPI values, and forwarding the service request to a selected producer NF based on the Group ID database.

### TECHNICAL FIELD

Various embodiments of the present technology generally relate to management of networks, such as fifth generation (5G) communications networks. More specifically, embodiments of the present technology relate to systems and methods for improved routing of service requests based on subscription permanent identifier (SUPI) values.

### BACKGROUND

In some communication network architectures, such as those using third generation partnership project (3GPP) standards, service may be implemented by establishing a user communication session, such as a UE (User Equipment) session or a PDU (packet data unit or protocol data unit) session. To support a voice or data call, a number of network functions (NFs) within a 5G network may work together to manage aspects of the session.

Subscribers to mobile networks may provide a subscriber ID, such as a subscription permanent identifier (SUPI) or generic public subscription identifier (GPSI), when establishing a communication session with a 5G network. A SUPI may be a globally unique identifier assigned to each subscriber in a 5G system, and may be written into the subscriber identity module (SIM), such as a physical universal integrated circuit card (UICC) or embedded SIM (eSIM). Mobile networks may use SUPI to identify, locate, and authenticate subscribers, for connecting calls, billing, and other operations. While the term SUPI may generally be used in the example embodiments presented herein, the teachings may be applicable to other types of subscriber IDs as well.

Mobile network operators may deploy certain NFs as part of groups, each having an NF Group ID, for catering to specific subscriber ID ranges or individual subscriber IDs. When determining what NFs to call to support a subscriber session, network components may contact a network repository function (NRF) and provide a SUPI value for the subscriber. However, NRFs may need to perform lookup operations and send various service messages within the network to determine appropriate Group IDs and corresponding NFs based on SUPI values, resulting in significant message latency. The lookup and mapping operations can also put significant processing load on NRFs. Additionally, some NRF vendors do not support Group ID resolution based on SUPI, and therefore deploying NFs to serve specific SUPIs can be a challenge for Telco operating companies. Accordingly, there exists a need for improved SUPI-based message routing to appropriate NFs within mobile networks.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for performing SUPI-based routing an SCP. In an embodiment, a service communications proxy (SCP) system may comprise one or more processors, and a memory having stored thereon instructions. The instructions, upon execution, may cause the one or more processors to receive a service request from a consumer network function (C-NF), the service request including a subscription permanent identifier (SUPI) value, access a Group ID database at the SCP based on the SUPI value, the Group ID database mapping ranges of SUPI values to groups of producer NFs configured to service particular ranges of SUPI values, and forward the service request to a selected producer NF based on the Group ID database

In some embodiments, the SCP system may access the Group ID database to determine a Group ID value of a group of producer NFs configured to service the SUPI value, and use the Group ID value to access a discovery response cache, the discovery response cache mapping Group ID values to discovery responses previously received from a network repository function (NRF). The discovery responses may include NF profiles for the producer NFs that are responsive to parameters of corresponding discovery requests. In some embodiments, the SCP system may access the discovery response cache to determine whether one of the discovery responses previously received from the NRF correspond to the service request, and when one of the discovery responses previously received from the NRF does correspond to the service request, forward the service request to the selected producer NF that was included in the one of the discovery responses previously received from the NRF. When one of the discovery responses previously received from the NRF does not correspond to the service request, the SCP system may issue a discovery request to the NRF for the service request, store the discovery response from the NRF to the discovery response cache, and forward the service request to the selected producer NF that was included in the discovery response. In some examples, the SCP system may obtain NF profile information from the NRF for producer NFs, the NF profile information including a SUPI range supported by a producer NF and a group ID for the producer NF, and generate the Group ID database based on the NF profile information. When the producer NF does not have group ID information in its NF profile, the SCP system may create an SCP-assigned group ID for the producer NF, and organize the producer NF based on the SCP-assigned group ID in the Group ID database. When one of the discovery responses previously received from the NRF does not correspond to the service request, the SCP system may determine whether the Group ID value from the Group ID database is a global group ID recognized by the NRF or an SCP-assigned group ID, when the Group ID value is the global group ID, issue the discovery request including the Group ID value, and when the Group ID value is the SCP-assigned group ID, issue the discovery request including the SUPI value. In some embodiments, the SCP system may map the discovery responses previously received from the NRF to a key based on the Group ID value and discovery query parameters excluding the SUPI value. The SCP system may remove the discovery responses previously received from the NRF from the discovery response cache when the discovery responses previously received from the NRF exceed a validity period.

In an alternative embodiment, a method may comprise operating a service communications proxy (SCP) of a mobile network, including receiving a service request from a consumer network function (C-NF), the service request including a subscription permanent identifier (SUPI) value, accessing a Group ID database at the SCP based on the SUPI value, the Group ID database mapping ranges of SUPI values to groups of producer NFs configured to service particular ranges of SUPI values, and forwarding the service request to a selected producer NF based on the Group ID database.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement SUPI-based routing at a service communications proxy, in accordance with certain embodiments of the present disclosure;

FIG. 2 depicts a flow diagram of a system configured to implement SUPI-based routing at a service communications proxy, in accordance with certain embodiments of the present disclosure;

FIG. 3 depicts a set of caches for implementing SUPI-based routing at a service communications proxy, in accordance with certain embodiments of the present disclosure;

FIG. 4 depicts a flow diagram of an example method to perform SUPI-based routing at a service communications proxy, in accordance with certain embodiments of the present disclosure;

FIG. 5 depicts a flow diagram of an example method to perform SUPI-based routing at a service communications proxy, in accordance with certain embodiments of the present disclosure;

FIG. 6 depicts a flowchart of an example method to SUPI-based routing at a service communications proxy, in accordance with certain embodiments of the present disclosure; and

FIG. 7 is a diagram of a system configured to implement SUPI-based routing at a service communications proxy, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

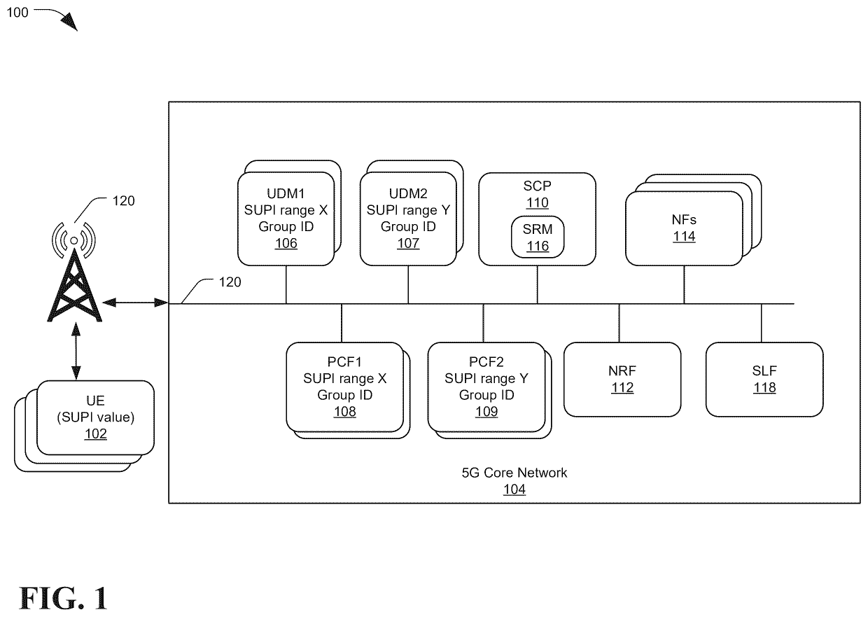

FIG. 1 is a diagram of a system 100 configured to implement SUPI-based routing at a service communications proxy, in accordance with certain embodiments of the present disclosure. The example system 100 may include a mobile network implementing 3GPP (3rd Generation Partnership Project) communication standards, although the present disclosure may apply to other communication networks. In particular, the mobile network may include components and elements to implement a cellular network, such as a 5G Core (5GC or 5GS) network 104. The system 100 may include one or more user equipment (UE) 102 connected to 5G network 104 via network connectivity components 120.

Each or any of UE 102, 5G network 104 and its components, and network 120 may be implemented via computers, servers, hardware and software modules, or other system components. The components of 5G network 104, or the physical devices implementing them, may be co-located, remotely distributed, or any combination thereof. The elements of system 100 may include components hosted or situated in the cloud, implemented as software modules potentially distributed across one or more server devices or other physical components, or otherwise implemented.

UE 102 may be a device, system, or module that may utilize the resources of the 5G network 104, such as to establish communications with another UE. Communication sessions may include, but are not limited to, IMS calls (Internet Protocol Multimedia subsystem), other cell phone calls, internet or other data connections, or any and all other types of communications sessions over 5G networks. UE 102 may include devices such as cell phones, tablets, modems, vehicles, desktop or laptop computers, televisions or set-top boxes, smart home devices, voice over IP (VoIP) devices, internet of things (IoT) devices, or any and all other systems that may utilize a cellular network. Each UE 102 may have a unique subscription permanent identifier (SUPI) value, which may be referred to as a subscriber ID. When connecting to the 5G network 104, the UE 102 may provide its SUPI value, which components of network 104 may use to manage the communication session.

Network connectivity components 120 may provide communication paths between UE 102 and 5G network 104. Network connectivity components 120 may comprise components that enable communication over communication links, such as network cards, ports, radio frequency (RF) modules, telecommunications channels, cell towers, switches, routers, processing circuitry and software, or other communication components. Network connectivity components 120 may include metallic, wireless, cellular, or optical links, using various communication formats and protocols. In some examples, network connectivity components 120 may simply be referred to as a “network” by which systems or modules are connected or communicate.

The 5G network 104 may comprise a mobile communications network that provides services to UEs 102 through the network connectivity components 120. 5G network 104 may include a plurality of components, modules, or network functions (NFs) configured to provide mobile communication services via the corresponding 5G Core communications protocols. Some components of 5G network 104 may be configured to communicate and operate with other networks, such as 4G networks, networks controlled by other network operators, or other network environments. Although referred to as a 5G core network 104, the network 104 may include components associated with 5G service, 4G service, or a combination thereof. 5G core network 104 may include one or more first unified data management module (UDM1) 106, one or more UDM2 107, one or more first policy control function (PCF1) 108, one or more PCF2 109, a service communications proxy (SCP) 110, a network or NF repository function (NRF) 112, a plurality of network functions (NFs) 114, and a subscriber locator function (SLF) 118.

The NRF 112 may be a monitoring element which includes and maintains a repository of NF profiles for available NF instances (including UDM1 106, UDM2 107, PCF1 108, PCF2 109, and NFs 114). The NF profiles may identify what services or resources each NF provides, and potentially metadata provided by the NF, which may specify vendor-specific features supported by the NF but not included in standard 3GPP specifications. For example, NFs may register to provide registration information and metadata regarding the NF to the NRF 112 for storing in the repository. Once an NF is registered with the NRF 112, the NRF may provide information regarding the NF in response to discovery requests. For example, an NF may send a discovery request to the NRF 112 including search criteria, and the NRF may issue a discovery response providing identifying information and metadata for NFs in the repository matching the search criteria. Consumer NFs can subscribe to receive information about producer NF instances that have registered with the NRF 112.

Network functions (NFs) 114 may generically refer to various network components or modules that provide and consume resources in order to facilitate subscriber communication sessions. NFs 114 may be categorized as consumer NFs (C-NFs) or producer NFs (P-NFs). A consumer NF may include an NF issuing a discovery or resource request (e.g., to NRF 112) in order to access a resource provided by a producer NF. A producer NF may be an NF that offers a resource corresponding to a resource request from a consumer NF. While NFs in specific examples may be categorized into “consumer” and “producer” NFs, the distinction may be purely based on which nodes are currently issuing NF discovery requests and which nodes may match or satisfy the requested criteria. A consumer NF may provide resources to the network 104, and may be a producer NF to other NF discovery requests, and likewise a producer NF may issue a discovery request and be a consumer NF in certain circumstances.

Service communications proxy (SCP) 110 may be a module that facilitates routing of service-based interface (SBI) messages among components of 5G network 104. An SCP 110 may subscribe with the NRF 112 to obtain reachability and service profile information regarding producer NF 114 service instances. Consumer NFs 114 can connect to the SCP 110, and the SCP can load balance traffic among producer NF service instances that provide the required service, or directly routes the traffic to the destined producer NF. If a C-NF sends a service request to an SCP 110 which does not have sufficient details on the requested P-NFs, the SCP 110 may issue a discovery request to the NRF 112 to obtain the P-NF profile information needed to forward the service request to an appropriate P-NF. 3GPP may provide a number of different implementation or deployment models for 5G networks 104, such as models A, B, C, and D. The models may define aspects of the network's infrastructure and capabilities of its components. Model A may include no NRF 112. Model B may include an NRF 112, but may not include SCPs 110 for traffic routing and balancing. Model C may include an NRF 112 and an SCP 110 for routing, but may not include an SCP configured for delegated discovery and indirect communication. Model D may include an NRF 112 and an SCP 110 configured to perform delegated discovery-based routing. Delegated discovery and routing may refer to a situation in which a consumer NF 114 specifies to the SCP 110 what service the consumer is seeking, and provides the SCP 110 with the service request. The SCP 110 may then determine P-NF 114 options for servicing the request, may select the P-NF to send the request to (and may select alternate P-NFs or routing if the initial request fails). Without delegated routing, a consumer NF may be required to select the P-NF itself. The proposals herein focus on Model C and Model D deployments in which an SCP 110 is included for message routing. The following discussions highlight Model D deployments, in which an SCP 110 is delegated P-NF 114 selection operations and forwards service request messages to a selected P-NF. However, Model C deployments are also supported, in which an SCP 110 may return discovery responses (either newly received from NRF 112 or cached at SCP 110) including appropriate P-NFs 114, and the C-NF can select a P-NF to send the service request to.

A unified data management (UDM) module or system, such as UDM1 106 and UDM 2 107, may manage network user data, such as for UE 102. A policy control function (PCF), such as PCF1 108 and PCF2 109, may be assigned to a subscriber session (e.g., a UE or a PDU session) created when a UE 102 registers with the 5G network 104 or when a UE attempts establishment of a PDU session, respectively. A PCF may generate policy rules for the session to control quality of service and charging for the session.

The UDM1 106, UDM2 107, PCF1 108, and PCF2 109 may be examples of specific types of NFs, and may register with the NRF 112. As noted above, registering with the NRF 112 may include providing metadata or other information to the NRF 112 identifying capabilities or configuration settings for the registering NFs. NFs may operate as individual units, or as part of an NF set or otherwise grouped, according to services provided or what SUPI values the NFs support. In some examples, the metadata provided to the NRF 112 may include group information for a set of related NF instances, which group of NFs may have an NF group ID.

In some implementations, network operators may deploy certain producer NF instances with NF group IDs to cater to specific subscriber ID (SUPI) ranges. With UDMs, for instance, a first plurality of UDMs may be grouped as UDM1 106, deployed to support SUPI range X, and a second plurality of UDMs may be grouped as UDM2 107, deployed to support SUPI range Y. Similarly with PCFs, a first plurality of PCFs may be grouped as PCF1 108, deployed to support SUPI range X, and a second plurality of PCFs may be grouped as PCF2 109, deployed to support SUPI range Y. Service requests related to a subscriber with a SUPI in range X should only be directed to UDM 1 106 or PCF1 108, and not to UDM2 107 or PCF2 109. In some examples, NFs may be configured to service specific SUPI values, but for ease of discussion specific supported values will also be referred to as SUPI ranges. Accordingly, when a discovery request is received at NRF 112 including a SUPI value, the NRF 112 may need to determine an appropriate NF group and related NF instances within that group to provide as part of the discovery response. When an NF registers with NRF 112, it may provide its Group ID or supported SUPI range, both elements, or neither.

Even when some NFs provide supported SUPI range information, Group ID information, or both when registering with an NRF 112, some NRF 112 implementations may not track SUPI to Group ID mappings. Subscriber locator function (SLF) 118 may provide information that enables the NRF 112 to map SUPI to Group ID and select appropriate producer NFs to provide in response to discovery requests. SLF 118 may be hosted by a user data repository (UDR) of the network. The procedure of receiving a discovery request from an SCP 110 at the NRF 112, and then for the NRF to reach out to the SLF 118 (via SCP 110) for the Group ID or SUPI range information, before returning the discovery response, can result in significant SBI messaging overhead within 5G core network 104, and introduce message latency.

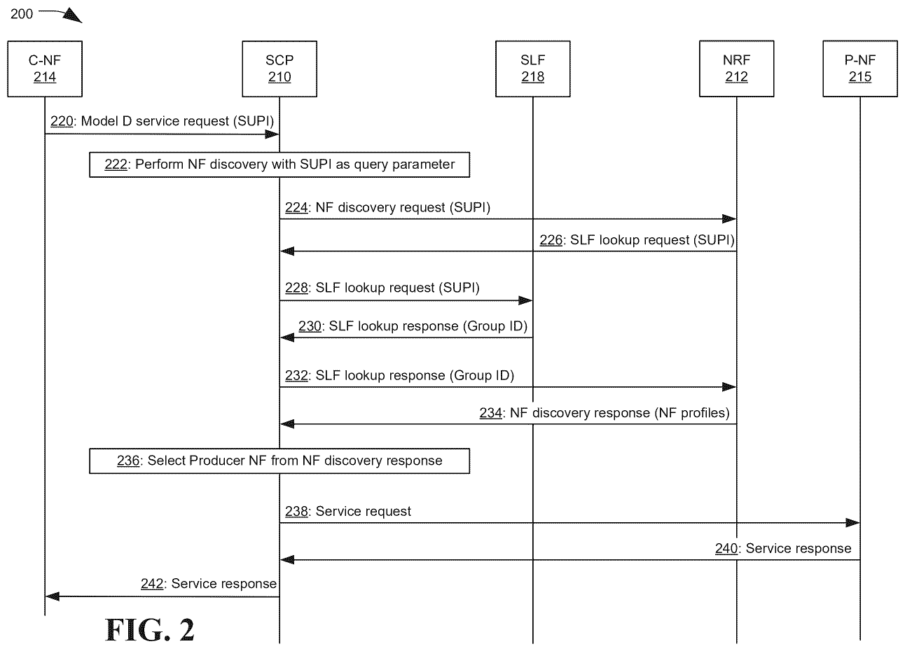

Accordingly, a SUPI routing module (SRM) 116 may be added to SCP 110. The SRM 116 may include operations enabling the SCP 110 to learn network topology for 5G core network 104, including SUPI to Group ID mappings. The SRM 116 may also include operations enabling the SCP 110 to cache discovery responses for particular query parameters and group IDs or SUPIs, allowing the SCP 110 to process and forward service requests to appropriate P-NFs (or in the case of a Model C deployment, provide a C-NF with a list of appropriate P-NFs) without the SBI message overhead associated with discovery requests to NRF 112. An example process flow depicting SBI message overhead on a service request without SUPI-based routing at the SCP 110 is described in regard to FIG. 2.

FIG. 2 depicts a flow diagram of a system 200 configured to implement SUPI-based routing at a service communications proxy, in accordance with certain embodiments of the present disclosure. In particular, the diagram 200 may depict a process flow within a 5G communication network by which SUPI-based routing to an appropriate producer NF is performed when an SCP does not include SUPI-to-Group ID mapping and an NRF must determine appropriate Group ID and producer NF instances. The depicted example is for a Model D deployment, although a Model C deployment without delegated discovery-based routing is also covered by the scope of the disclosure. Diagram 200 may depict an example message and processing flow between a C-NF 214, SCP 210, SLF 218, NRF 212, and P-NF 215. The components in diagram 200 may correspond to elements described in regard to FIG. 1.

At 220, C-NF 214 may issue a model D SBI service request, including a SUPI value of the subscriber associated with the communication session, to SCP 210. At 222, the SCP 210 may determine it doesn't have any relevant SUPI to Group ID mapping or network topology information, and may therefore perform an NF discovery operation to NRF 212. At 224, the SCP 210 may issue an NF discovery request, with SUPI as a parameter, to NRF 212.

At 226, NRF 212 may receive the discovery request, and may issue an SLF lookup request, with SUPI as a parameter, to SCP 210 for routing to SLF 218. At 228, SCP 210 may forward the SLF lookup request to SLF 218, and at 230 the SLF may provide an SLF lookup response, including a Group ID corresponding to the provided SUPI, to SCP 210. At 232, SCP 210 may forward the SLF lookup response with Group ID to NRF 212.

NRF 212 may use the Group ID information from the SLF response to determine which producer NFs are part of the NF group corresponding to the SUPI value, and retrieve the appropriate NF profiles. At 234, the NRF 212 may provide an NF discovery response with the selected NF profiles to SCP 210.

At 236, SCP 210 may select a producer NF from the NF discovery response to which to send the service request 220 (or in a Model C deployment, may return the discovery response results to C-NF 214 for selection of a P-NF 215 and sending the service request). At 238 SCP 210 may forward the service request to the selected P-NF 215. P-NF 215 may issue a service response to SCP 210, at 240, and SCP 210 may forward the service response to C-NF 214, at 242.

As may be appreciated from the flow diagram, when SCP 210 is unaware of the Group ID corresponding to a SUPI from a service request, and must perform a discovery request to NRF 212, it may result in multiple SBI service messages being passed across the network. The latency resulting from messages from SCP 210 to NRF 212 (224), back to SCP 210 (226), from SCP to SLF 218 (228), from SLF to SCP (230), from SCP to NRF 212, and finally NRF back to SCP (234) adds significant message latency to the 220 service request. Ultimately, between issuing the service request 220 and receiving the service response 242, there may be ten SBI messages issued across the network.

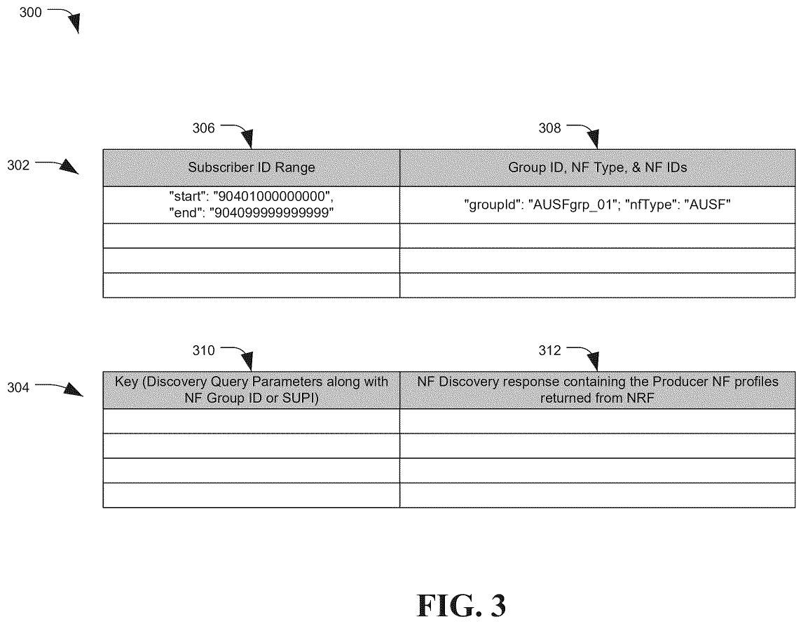

This message latency overhead may be reduced by configuring the SCP 210 to cache selected valuable information on network topology and SUPI to Group ID mapping. Such cached information may reduce or eliminate the messages required to be passed between SCP 210, NRF 212, and SLF 218 for each service request. Details on the information to cache at the SCP is discussed in regard to FIG. 3.

FIG. 3 depicts a set of caches 300 for implementing SUPI-based routing at a service communications proxy, in accordance with certain embodiments of the present disclosure. In particular, the set of caches or databases (DBs) 300 may be maintained at an SCP of a mobile network, and may enable the SCP to perform improved SUPI-based routing by limiting or eliminating message exchanges with an NRF for routing SBI service requests. The set of caches may include a SUPI to Group ID mapping cache 302 and a discovery response cache 304.

SUPI to Group ID mapping cache 302 may map a subscriber ID range (e.g., a SUPI range or individual SUPI values, or a GSPI range or individual GPSI values) 306 to information such as a Group ID, NF Type, and NF IDs 308 for P-NFs configured to service SUPIs within the corresponding range 306. For example, for a SUPI range of 904010000000000 to 904099999999999, there may be a first cache row for a Group ID of authentication server functions (AUSFs) NF Type that service the range, and additional rows for Group IDs of other NF types that service that range or other ranges, etc. In some embodiments, the SUPI ranges supported by different NF types may be different (e.g., x100-x999 for UDMs, but x100-x499 for PCFs). Some data elements may be optional, for example within the Group ID, NF Type, and NF ID column 308, nfInstanceId may be a possible stored value, but may not be needed in SUPI range to Group ID mapping created based on an SCP learning NF topology from an NRF.

The SCP may maintain the cache 302 as a virtual SLF database, so that Group ID information can be obtained without the NRF needing to query the SLF. In this manner, when an SCP receives a service request including a SUPI, the SCP can look up the corresponding Group ID for the requested NF type or ID without contacting the NRF. The SCP can then either send a discovery request to the NRF that already includes the relevant group ID, or depending on the information available in discovery response cache 304, bypass contacting the NRF entirely.

The SCP may build or populate the SUPI to Group ID cache 302 from network topology learning, based on information about NF groups and the associated NF Types and IDs obtained from NRFs of the network. The SCP may use information obtained from the NRF via NRF subscriptions, NRF audits, and previous NF discovery responses from the NRF. For example, the SCP may utilize procedures such as NFListProfileRetrieval, NFProfileRetrieval, NFStatusSubscribe or NFStatusNotify, or other operations that may provide Group IDs for P-NFs and the associated SUPI ranges supported. SCP may subscribe to NRF for any NF profile changes for all NF Types for 5G NF network topology learning. Accordingly, if there is any change in SUPI range or Group ID attributes of an NF profile, then SCP will receive a notification from NRF, and can update the SUPI to Group ID mapping cache 302. In this manner, SCP may always have SUPI to Group ID mapping updated and synced with NRF. In case of no SUPI to Group ID information being included in an NF profile from NRF, then SCP can assign an SCP-internal usage Group ID, as explained below.

When an NF registers with the NRF to create an NF Profile, the NF may provide various information about itself, including an associated group ID, a supported SUPI range, or both. The NRF itself may not track and map this information, but may merely store it as NFProfile metadata. An example NF Profile for a AUSF NF may look like:

```
{
  ″nfInstanceId″: ″5f845dd2-a2dc-4df1-f0ff-8882c4ad9b7e″,
  ″nfType″: ″AUSF″,
  ″nfStatus″: ″REGISTERED″,
  ″plmnList″: [
    {
      ″mcc″: ″xx″,
      ″mnc″: ″yy″
    }
  ],
  ″fqdn″: ″ausf01.loc1.ausf.5gc.mncxxx.mccyyy.3gppnetwork.org″,
  ″interPlmnFqdn″: ″ausf01.loc1.ausf.5gc.mncxxx.mccyyy.
3gppnetwork.org″,
  ″priority″: 0,
  ″capacity″: 65535,
  ″locality″: ″loc1″,
  ″ausfInfo″: {
    ″groupId″: ″AUSFgrp_01″,
    ″supiRanges″: [
      {
        ″start″: ″904010000000000″,
        ″end″: ″904099999999999″
      }
    ]
  }
```

When an NRF provides NF profile information to the SCP, the SCP may utilize metadata elements from the profile to populate the SUPI to Group ID cache 302. For example, the SCP may fill in the SUPI ranges, Group ID, and NF information as shown in cache 302. The SCP may store the data in other formats, such as in a data structure format of (NF Type, SUPI range, Group Id) resulting in, e.g., [AUSF, {“start”: “904010000000000”, end”: “904099999999999”}, AUSFgrp_01] for an NF of type AUSF. Information about SUPI to Group ID mapping obtained from sources other than NF profiles may also be used to populate the SUPI to Group ID mapping cache 302.

In some embodiments, an NF may publish a Group ID value but not a supported SUPI range. In such instances, an SCP may not be able to add the NF (or its associated group) to the SUPI to Group ID mapping table 302 based on the published NF profile information alone. This may be because the SCP does not know the supported subscriber ID range 306 for the NF in order to map to the Group ID. However, after performing a discovery request to NRF based on a specific SUPI and obtaining NF information with a Group ID, as described below, that specific SUPI value and corresponding Group ID information may be added to the SUPI to Group ID table 302.

When the SCP receives an SBI service request with an included SUPI, the SCP may look up whether the SUPI falls within a subscriber ID range 306 of the SUPI to Group ID cache 302. If not, the SCP may issue a discovery request to the NRF as normal, and may obtain relevant NF information, Group ID information, or both with which to populate the SUPI to Group ID cache 302. If the SUPI is already included in row 306 (e.g., as an individual value or falling within a range) from the Group ID cache 302, the SCP may obtain the relevant Group ID (for the NF type or NF ID specified in the service request).

After locating the Group ID information, the SCP may generate a lookup key based on discovery query parameters that would be sent to an NRF, including Group ID or SUPI. The lookup key can be compared against the Key field 310 of the discovery request cache or DB 304. If the SCP has previously issued a discovery request with the specified parameters (e.g., including Group ID or SUPI), the SCP would store the results in the NF discovery response field 312 of the discovery response cache 304. The discovery response information 312 may include the data required to select a Producer NF for handling the corresponding service request, and forwarding the request to the selected P-NF (in model D deployments) or returning the discovery response to a consumer NF (in model C deployments). Accordingly, if a relevant discovery response is already stored in the discovery response cache 304, the SCP can access the Producer NF profile information and forward the service request without contacting the NRF at all. If the key produced with the Group ID does not match an entry in the discovery response cache 304, the SCP may perform a discovery request to the NRF using the Group ID value or SUPI. Providing the Group ID information in the discovery request may prevent the NRF from needing to contact an SLF for the Group ID information, and reduce message latency. When the SCP receives the discovery response, the SCP may update the discovery response cache 304, and potentially the SUPI to Group ID mapping table, with the information from the discovery response.

The key field 310 of the discovery response cache may include either Group ID information or SUPI information, depending on what is available to the SCP. When the Group ID for a SUPI value is available from the SUPI to Group ID cache 302, the SUPI value may be excluded from the key values 310 to keep the discovery response cache 304 to a manageable size, and a specific SUPI value is not needed to find a relevant discovery response when a Group ID value is known. However, if the Group ID for a SUPI value is not known or is not included in the SUPI to Group ID cache (e.g., in embodiments where an NF publishes a Group ID but no supported SUPI range), the SCP may issue the discovery request with the SUPI value and use that request as the Key 310 for the discovery response cache 304. Discovery responses may be retained in the discovery response cache or DB 304 for a validity period of the discovery response, after which a stored response may be removed (e.g., to prevent outdated NF information from being used).

As discussed above, discovery responses may be cached based on a key 310 including a SUPI value, such as when an the SUPI value was not located in the SUPI to Group ID cache 302 because an NF published a Group ID but no supported SUPI range, and so the discovery request must be based on a SUPI value from the service request. In another embodiment, the SUPI-to-Group ID cache 302 may be updated based on the discovery response, with the SUPI value mapped to the Group ID of the producer NFs identified in the discovery response. In this manner, the key 310 for the discovery response cache 304 may still be generated with a Group ID value instead of SUPI value, as future requests for the same SUPI will produce a cache hit with a Group ID on the SUPI to Group ID cache 302. Although the SCP may still not know of the supported SUPI range for a Group ID that does not publish a supported SUPI range, the SCP may consolidate SUPI to Group ID map entries if multiple SUPIs map to the same Group ID.

In some embodiments an NF may specify a supported SUPI range, but may not indicate a Group ID. In this case, SCP may create and assign a Group ID for the SUPI range, and store it in the SCP's SUPI to group ID cache or DB 302. For example, an SCP may store a SUPI range with an SCP-assigned Group ID in the SUPI to Group ID DB 302 as [AUSF, {“start”: “904010000000000”, “end”: “904099999999999”}, scpAssignedGroup_01]. SCP-assigned Group IDs may be used locally at the SCP for NF discovery caching (e.g., as part of a key 310 or data lookup point for discovery response cache or DB 304), and may not be included in NF discovery requests sent to the NRF. Instead, discovery requests for a SUPI with an SCP-assigned Group ID may still use the SUPI value rather than the Group ID value.

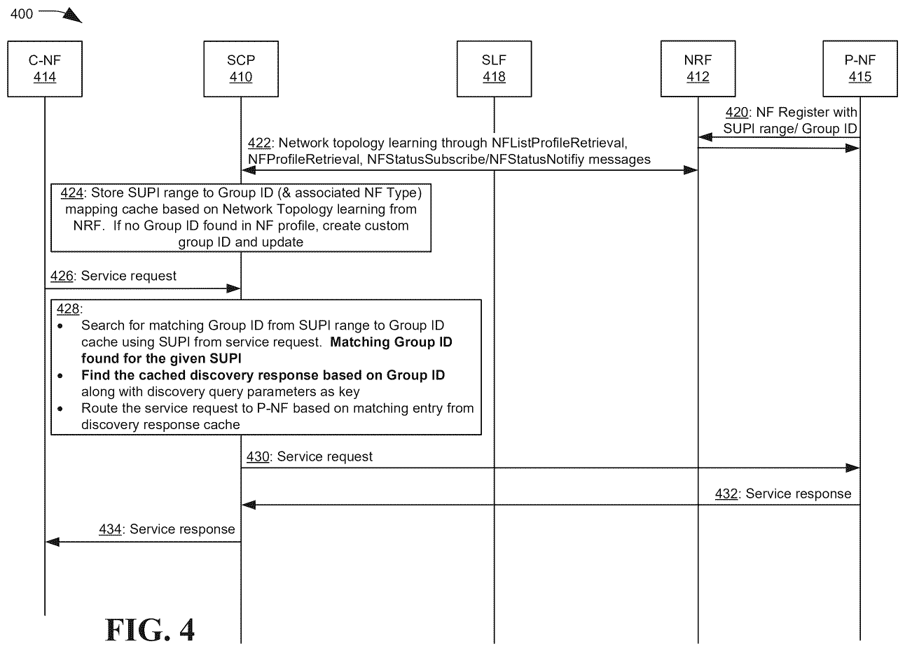

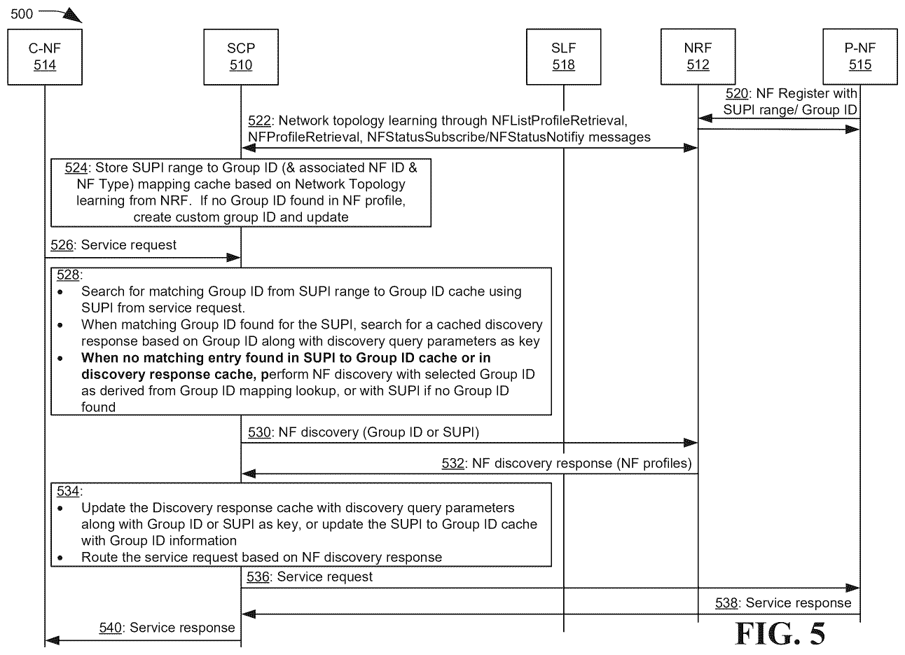

When an SCP receives a service request with a SUPI that falls within a range covered by an SCP-assigned Group ID value, the SCP may generate a lookup key 310 based on the Group ID value and discovery query parameters, and excluding the SUPI value. If there is a match, the SCP may use the cached discovery response 312 to select and send the service request to a P-NF (in a model D deployment) or return the cached response 312 to the C-NF (in a model C deployment). However, if there is not a hit in the discovery response cache 304, the SCP may send a discovery request to the NRF with the SUPI value from the service request. The SCP may not send the NRF its SCP-assigned Group ID value, as the NRF may not recognize the value or be able to access NF profiles based on it. When the discovery response is received, the SCP may cache the response 312 in the discovery response cache 304, with a lookup key 310 based on the SCP-assigned Group ID value and not including the SUPI value. In this way, the SCP can cache discovery responses without relying on individual SUPI values (e.g., thereby maintaining a reasonable discovery cache 304 size), even when there is no global Group ID value available from NF profiles at the NRF. Future service requests from C-NFs that fall within a SUPI range of the SCP-assigned Group ID value may enable lookup of the cached discovery response, and therefore the SCP may contact an appropriate P-NF without the need to send traffic to the NRF. This can reduce traffic load on the network and processing load at the NRF. Example process flows for SUPI-based routed at an SCP are described in regard to FIGS. 4 and 5.

FIG. 4 depicts a flow diagram 400 of an example method to perform SUPI-based routing at a service communications proxy, in accordance with certain embodiments of the present disclosure. In particular, the diagram 400 may depict a process flow within a 5G communication network by which SUPI-based routing is performed via an SCP, when the SCP finds a matching Group ID in a SUPI to Group ID cache and a matching entry in a discovery response cache, as discussed in regard to FIG. 3. Diagram 400 may depict an example message and processing flow between a C-NF 414, SCP 410, SLF 418, NRF 412, and P-NF 415. The components in diagram 400 may correspond to elements described in regard to FIG. 1.

At 420, P-NF 415 may register with NRF 412, such as by providing information to store in an NF profile. The provided information may include a SUPI range supported by the P-NF 415, a Group ID value, other information, or a combination thereof. NRF 412 may store the NF profile information within its database and return a success response to P-NF 415. At 422, SCP 410 may learn the network topology (e.g., details on NFs, including NF Type, supported SUPI range, and associated Group ID values) from NRF 412 via operations to obtain NF updates, such as NFListProfileRetrieval, NFProfileRetrieval, NFStatusSubscribe, or NFStatusNotify messages. At 424, SCP 410 may populate a local database or cache with the learned topology information, such as by populating a SUPI to Group ID mapping table, database, or cache, and associated NF Type information. If no Group ID information is found in an NF profile, SCP 410 may create a custom Group ID to add to the cache for an associated SUPI range. If a Group ID but no supported SUPI values are found in an NF profile, SCP 410 may be unable to map any SUPIs to those NFs until those NFs are returned in response to a discovery request for a SUPI value.

At 426, SCP 410 may receive a service request from C-NF 414. The service request may be a request for a network service provided by a producer NF (e.g., P-NF 415), and the request may be a model C request, or a model D request where C-NF 414 delegates producer NF discovery and routing to SCP 410. The service request may include a SUPI value for a subscriber device associated with a communication session for the service request.

At 428, SCP 410 may use SUPI value from the service request as a key to search a SUPI-to-Group ID mapping cache at SCP 410. In the example embodiment of FIG. 4, SCP 410 may successfully find a matching Group ID for a SUPI range including the SUPI value. The Group ID may be a value obtained from an NF profile, or it may have been assigned by SCP 410. SCP 410 may further use the Group ID and discovery query parameters (e.g., parameters that would normally be used to query NRF 412 for a list of P-NFs based on the service request) as a key to access a discovery response cache of the SCP 410. The key may exclude the SUPI value to limit the size of the discovery response cache. In the example of FIG. 4, the SCP may successfully locate a cached discovery response for the Group ID and discovery parameters. The cached discovery response may be a previous discovery response from NRF 412 to SCP 410 for a similar discovery query on the same SUPI range or Group ID value, and may provide additional details on P-NF 415 used for performing messaging from SCP 410 to P-NF 415 (in a model D deployment), or for messaging from C-NF 414 to P-NF 415 (in a model C deployment).

Based on the cached discovery response, SCP 410 may route the SBI service request to P-NF 415, at 430 (either directly in a model D deployment, or by providing relevant information to C-NF 414 in a model C deployment). P-NF 415 may receive the service request and generate a service response, which it may send to SCP 410, at 432. SCP 410 may receive the service response and forward it to C-NF 414, at 434.

The embodiment of FIG. 4 eliminates the need for performing a discovery request from SCP 410 to NRF 412, which further eliminates any messaging to SLF 418 for Group ID lookup. Starting from the service request from C-NF 414, there may only be four messaging hops within the network (e.g., 426, 430, 432, and 434), compared to ten message hops in the example of FIG. 2. The proposed operations therefore reduce network messaging load, and reduce processing load at NRF 412 and SLF 418. Another example process flow is described in regard to FIG. 5.

FIG. 5 depicts a flow diagram 500 of an example method to perform SUPI-based routing at a service communications proxy, in accordance with certain embodiments of the present disclosure. In particular, the diagram 500 may depict a process flow within a 5G communication network by which SUPI-based routing is performed via an SCP, when the SCP finds a matching Group ID in a SUPI to Group ID cache, but does not find a matching Group ID-based entry in a discovery response cache, as discussed in regard to FIG. 3. Diagram 500 may depict an example message and processing flow between a C-NF 514, SCP 510, SLF 518, NRF 512, and P-NF 515. The components in diagram 500 may correspond to elements described in regard to FIG. 1.

As described in regard to diagram 400, P-NF 515 may register with NRF 512, at 520, providing supported SUPI range, Group ID information, both, or neither. At 522, SCP 510 may perform network topology learning to determine SUPI ranges and Group IDs for P-NFs. At 524, SCP 510 may populate a SUPI range to Group ID cache or DB based on the topology learning, including creating and assigning custom Group ID values for P-NFs that do not identify a global Group ID value.

At 526, C-NF 514 may send a model C or D service request SBI message to SCP 510, including a SUPI value. At 528, SCP 510 may search its SUPI range to Group ID mapping cache based on the SUPI value. When a matching Group ID value for the SUPI value is located, SCP 510 may search for a cached discovery response in a discovery response cache based on the identified Group ID information and discovery query parameters. When the SUPI value is not located in the SUPI to Group ID mapping cache, however, or when SCP 510 fails to find a matching entry in the discovery response cache based on an identified Group ID, SCP 510 may perform a discovery operation.

Accordingly, at 530, SCP 510 may perform an NF discovery operation to NRF 512. If the SCP 510 found a global Group ID value in the SUPI to Group ID cache, SCP 510 may provide the Group ID value in lieu of the SUPI value with the NF discovery request. However, if SCP 510 found an SCP-assigned Group ID value, SCP 510 may instead provide the SUPI value with the discovery request. This scenario may arise for producer NFs who publish a supported SUPI range, but do not publish a Group ID, for example. Similarly, SCP 510 may also provide the SUPI value in the NF discovery operation when SCP 510 fails to find a SUPI-to-Group ID mapping, for example when an NF producer only publishes a Group ID value and not a supported SUPI range. NRF 512 may perform an SLF 518 lookup operation (not shown) in instances where SCP 510 provides a SUPI value with the discovery request. At 532, NRF 512 may provide an NF discovery response, including NF profile information relevant to the service request, to SCP 510.

At 534, SCP 510 may use the received discovery response to update its local caches or databases. For example, if the discovery request included a SUPI value, and the discovery response returned one or more NFs having a published Group ID but no supported SUPI range, SCP 510 may update its SUPI to Group ID mapping table based on the returned NFs. SCP 510 may also update the discovery response cache to include the received discovery response. The cached response may be mapped based on the discovery request parameters as key, which may include the SUPI value, a Group ID previously known to the SCP 510, or a Group ID identified based on the discovery response itself and updated the SUPI to Group ID mapping cache. SCP 510 may also note a validity period or time received for the discovery response, so that it knows when to purge or disregard discovery responses that are no longer valid.

Based on the discovery response, SCP 510 may route the service request to an appropriate P-NF 515, at 536, and receive a service response at 538. At 540, SCP 510 may forward the service response to C-NF 514.

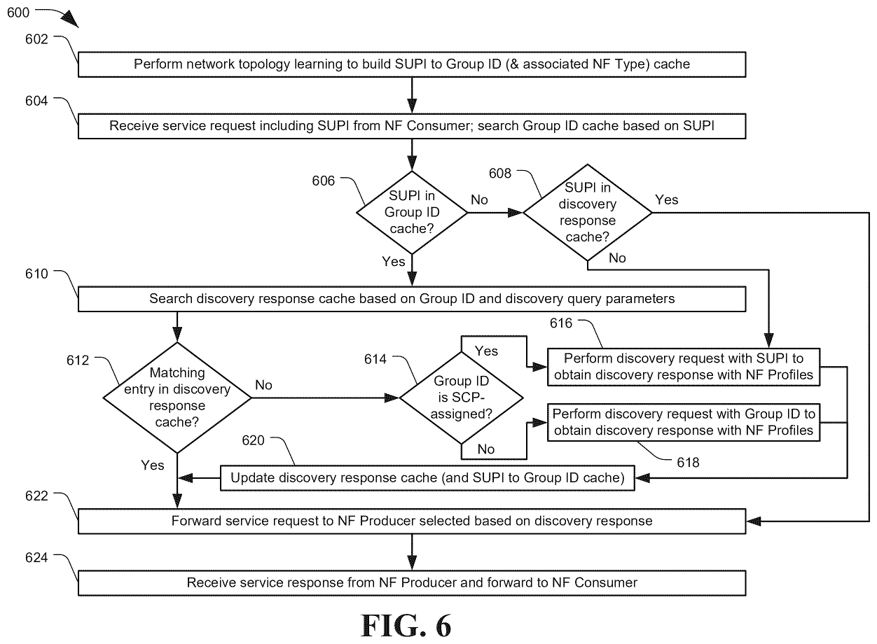

Compared to the embodiment of FIG. 2, the embodiment of FIG. 5 may still involve performing a discovery request from SCP 510 to NRF 512, but may eliminate the need for NRF 512 to access SLF 518 for Group ID information in instances where the Group ID is provided in the NF discovery request. Accordingly, the number of network message hops from initiation of the service request at 526 may be reduced from ten to six, still providing a significant improvement. An example method of performing SUPI-based routing via an SCP is described in further detail in regard to FIG. 6.

FIG. 6 depicts a flowchart 600 of an example method to SUPI-based routing at a service communications proxy, in accordance with certain embodiments of the present disclosure. In particular, flowchart 600 depicts an example process by which an SCP may create a local database of routing information based on SUPI ranges and Group ID values, and route service requests based on the local routing information. The method of flowchart 600 may be executed by an SCP, such as SCPs 110, 210, 410, and 510 of FIGS. 1, 2, 4, and 5, respectively.

At 602, the method may include performing network topology learning to build a SUPI to Group ID (and potentially other information, such as associated NF type information) cache or database. An SCP may obtain information about SUPI ranges, Group ID values, and NF types from NF Profiles stored at an NRF, and may subscribe to the NRF to be kept updated on changes to NF profiles.

At 604, the method may include receiving a model C or D service request SBI message, including a SUPI value, from a consumer NF, and searching the SUPI range to Group ID cache based on the received SUPI value. At 606, a determination may be made whether the SUPI value is found in the Group ID cache.

If the SUPI value is not found in the Group ID cache, such as when an NF publishes a Group ID but not a supported SUPI range, then in some embodiments the method may include searching the discovery response cache using the SUPI and other discovery parameters as a key, and determining whether there was a hit, at 608. If there is a cached response, the method may include forwarding the service request to an appropriate NF producer based on the cached response (for a model D deployment), or providing the cached response to the NF consumer (for a model C deployment, at 622. If the SUPI value does not match any cached responses in the discovery response cache, at 608, the method may include performing a discovery request using the SUPI value to obtain a discovery response with appropriate NF profiles for the SUPI value, at 616. At 620, the discovery response cache may then be updated with the received response, and using SUPI and the discovery parameters as a key. In other embodiments, discovery responses may not be cached based on SUPI value, and therefore if the SUPI is not in the Group ID cache, at 606, the method may include performing the discovery response with the SUPI value, at 616. In these instances, the method may include receiving the discovery response and determining a Group ID (or assigning an SCP-generated Group ID) for the returned NF profiles, and updating the SUPI to Group ID cache based on the discovery response, at 620. The discovery response cache may also be updated with the discovery response, with the newly mapped Group ID and other discovery parameters used as a key, also at 620.

If the SUPI value is found in the Group ID cache, at 606, the method may include searching a discovery response cache at the SCP based on the identified Group ID and discovery query parameters for the service request, at 610. The discovery response cache may be searched based on a global Group ID value, or based on an SCP-assigned Group ID value.

At 612, a determination may be made whether a matching entry was found in the discovery response cache based on the Group ID value and discovery query parameters. If not (indicating no prior discovery request has been sent from the SCP to the NRF for that same Group ID and discovery parameters within a validity period of the discovery response), the method may include determining whether the Group ID for the SUPI range is an SCP-assigned Group ID value, at 614. If not, the Group ID may be a global Group ID value that can be recognized by an NRF, and accordingly the method may include performing a discovery request with the Group ID value included, to obtain a discovery response with relevant NF profiles, at 618. If, however, the Group ID value is SCP-assigned, at 614, the method may include performing a discovery request with the SUPI value in order to obtain a discovery response with relevant NF profiles, at 616. This may be because an NRF would not recognize an SCP-assigned Group ID value, and may require the SUPI value instead.

After performing a discovery request at 616, or 618, the method may include updating the discovery response cache of the SCP, at 620. The discovery responses may include NF profile information for producer NFs relevant to the discovery request (and therefore relevant to the service request from 604). The SCP may access previous discovery requests from the discovery response queue based on the corresponding Group ID (or SUPI) and relevant discovery parameters for determining P-NFs to handle the service request.

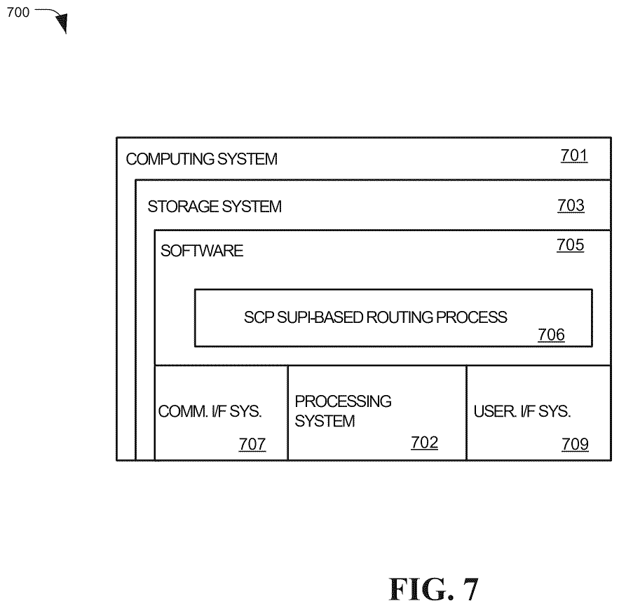

When a relevant cached discovery response is located, at 612, or a new discovery response is received and cached, at 620, the method may include forwarding the service request to an NF producer selected based on the discovery response (for a model D deployment), or providing the response to the NF consumer (for a model C deployment), at 622. A service response may then be received from the NF producer and forwarded to the NF consumer that issued the initial service request, at 624. A computing system configured to perform the operations and methods described herein is provided in regard to FIG. 7.

FIG. 7 illustrates an apparatus 700 including a computing system 701 that is representative of any system or collection of systems in which the various processes, systems, programs, services, and scenarios disclosed herein may be implemented. Examples of computing system 701 include, but are not limited to, desktop computers, laptop computers, server computers, routers, web servers, cloud computing platforms, and data center equipment, as well as any other type of physical or virtual server machine, physical or virtual router, container, and any variation or combination thereof.

Computing system 701 may be implemented as a single apparatus, system, or device or may be implemented in a distributed manner as multiple apparatuses, systems, or devices. Computing system 701 may include, but is not limited to, processing system 702, storage system 703, software 705, communication interface system 707, and user interface system 709. Processing system 702 may be operatively coupled with storage system 703, communication interface system 707, and user interface system 709.

Processing system 702 may load and execute software 705 from storage system 703. Software 705 may include and implement SCP SUPI-based routing process 706, which may be representative of any of the operations for determining network topology of producer NFs, identifying SUPI ranges services by groups of NFs, identifying or assigning Group ID values for NFs associated with SUPI ranges, and using databases or caches of NF group information and discovery responses to route service requests, while minimizing network traffic and processing at NRFs and SLP modules, as discussed with respect to the preceding figures. When executed by processing system 702, software 705 may direct processing system 702 to operate as described herein for at least the various processes, operational scenarios, and sequences discussed in the foregoing implementations. Computing system 701 may optionally include additional devices, features, or functionality not discussed for purposes of brevity.

In some embodiments, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 may include general purpose central processing units, graphical processing units, application specific processors, and logic devices, as well as any other type of processing device, combinations, or variations thereof.

Storage system 703 may comprise any memory device or computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including SCP SUPI-based routing process 706 among other functions) may be implemented in program instructions that may, when executed by processing system 702, direct processing system 702 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system as described herein. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable storage medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A service communications proxy (SCP) system, comprising:
one or more processors; and
a memory having stored thereon instructions that, upon execution by the one or more processors, cause the one or more processors to:
receive a service request from a consumer network function (C-NF), the service request including a subscription permanent identifier (SUPI) value;
access a Group ID database at the SCP based on the SUPI value, the Group ID database mapping SUPI values to groups of producer NFs configured to service particular SUPI values; and
forward the service request to a selected producer NF based on the Group ID database.

2. The SCP system of claim 1, wherein the instructions comprise further instructions that, upon execution by the one or more processors, cause the one or more processors to:
access the Group ID database to determine a Group ID value of a group of producer NFs configured to service the SUPI value; and
use the Group ID value to access a discovery response cache, the discovery response cache mapping Group ID values to discovery responses previously received from a network repository function (NRF).

3. The SCP system of claim 2, wherein the discovery responses include NF profiles for the producer NFs that are responsive to parameters of corresponding discovery requests.

4. The SCP system of claim 3, wherein the instructions comprise further instructions that, upon execution by the one or more processors, cause the one or more processors to:
access the discovery response cache to determine whether one of the discovery responses previously received from the NRF correspond to the service request; and
when one of the discovery responses previously received from the NRF does correspond to the service request, forward the service request to the selected producer NF that was included in the one of the discovery responses previously received from the NRF.

5. The SCP system of claim 4, wherein the instructions comprise further instructions that, upon execution by the one or more processors, cause the one or more processors to:
when one of the discovery responses previously received from the NRF does not correspond to the service request,
issue a discovery request to the NRF for the service request;
store the discovery response from the NRF to the discovery response cache; and
forward the service request to the selected producer NF that was included in the discovery response.

6. The SCP system of claim 5, wherein the instructions comprise further instructions that, upon execution by the one or more processors, cause the one or more processors to:
obtain NF profile information from the NRF for producer NFs, the NF profile information including a SUPI range supported by a producer NF and a group ID for the producer NF; and
generate the Group ID database based on the NF profile information.

7. The SCP system of claim 6, wherein the instructions comprise further instructions that, upon execution by the one or more processors, cause the one or more processors to:
when the producer NF does not have group ID information in its NF profile,
create an SCP-assigned group ID for the producer NF; and
organize the producer NF based on the SCP-assigned group ID in the Group ID database.

8. The SCP system of claim 7, wherein the instructions comprise further instructions that, upon execution by the one or more processors, cause the one or more processors to:
when one of the discovery responses previously received from the NRF does not correspond to the service request,
determine whether the Group ID value from the Group ID database is a global group ID recognized by the NRF or an SCP-assigned group ID;
when the Group ID value is the global group ID, issue the discovery request including the Group ID value; and
when the Group ID value is the SCP-assigned group ID, issue the discovery request including the SUPI value.

9. The SCP system of claim 8, wherein the instructions comprise further instructions that, upon execution by the one or more processors, cause the one or more processors to:
map the discovery responses previously received from the NRF to a key based on the Group ID value and discovery query parameters excluding the SUPI value.

10. The SCP system of claim 9, wherein the instructions comprise further instructions that, upon execution by the one or more processors, cause the one or more processors to:
remove the discovery responses previously received from the NRF from the discovery response cache when the discovery responses previously received from the NRF exceed a validity period.

11. A method comprising:
operating a service communications proxy (SCP) of a mobile network, including:
receiving a service request from a consumer network function (C-NF), the service request including a subscription permanent identifier (SUPI) value;
accessing a Group ID database at the SCP based on the SUPI value, the Group ID database mapping SUPI values to groups of producer NFs configured to service particular SUPI values; and
forwarding the service request to a selected producer NF based on the Group ID database.

12. The method of claim 11, further comprising:
accessing the Group ID database to determine a Group ID value of a group of producer NFs configured to service the SUPI value; and
using the Group ID value to access a discovery response cache, the discovery response cache mapping Group ID values to discovery responses previously received from a network repository function (NRF).

13. The method of claim 12, wherein the discovery responses include NF profiles for the producer NFs that are responsive to parameters of corresponding discovery requests.

14. The method of claim 12, further comprising
accessing the discovery response cache to determine whether one of the discovery responses previously received from the NRF correspond to the service request; and
forwarding the service request to the selected producer NF that was included in the one of the discovery responses previously received from the NRF when one of the discovery responses previously received from the NRF does correspond to the service request.

15. The method of claim 14, further comprising:
when one of the discovery responses previously received from the NRF does not correspond to the service request,
issuing a discovery request to the NRF for the service request;
storing the discovery response from the NRF to the discovery response cache; and
forwarding the service request to the selected producer NF that was included in the discovery response.

16. The method of claim 15, further comprising:
when one of the discovery responses previously received from the NRF does not correspond to the service request,
determining whether the Group ID value from the Group ID database is a global group ID recognized by the NRF or an SCP-assigned group ID;
issuing the discovery request including the Group ID value when the Group ID value is the global group ID; and
issuing the discovery request including the SUPI value when the Group ID value is the SCP-assigned group ID.

17. The method of claim 12, further comprising:
mapping the discovery responses previously received from the NRF to a key based on the Group ID value and discovery query parameters excluding the SUPI value.

18. The method of claim 12, further comprising:
removing the discovery responses previously received from the NRF from the discovery response cache when the discovery responses previously received from the NRF exceed a validity period.

19. The method of claim 11, further comprising:
obtaining NF profile information from a network repository function (NRF) for producer NFs, the NF profile information including a SUPI range supported by a producer NF and a group ID for the producer NF; and
generating the Group ID database based on the NF profile information.

20. The method of claim 19, further comprising
when the producer NF does not have group ID information in its NF profile,
creating an SCP-assigned group ID for the producer NF; and
organizing the producer NF based on the SCP-assigned group ID in the Group ID database.
